(19) United States
(12) Patent Application Publication
(10) Pub. No.: US 2017/0043459 A1
(43) Pub. Date: Feb. 16, 2017

(54) COMPLIANT FASTENER STARTER FOR SIMULTANEOUS HARDWARE INSTALLATION

(71) Applicant: Raytheon Company, Waltham, MA (US)

(72) Inventors: Blair Simons, Clearwater, FL (US); Alexandra Cintron-Aponte, Pinellas Park, FL (US)

(21) Appl. No.: 14/825,698

(22) Filed: Aug. 13, 2015

(51) Int. Cl. B25B 23/10

(52) U.S. Cl. CPC B25B 23/101

(57) ABSTRACT

An apparatus includes an open-mouth inlet at a first end and an outlet at a second end distal from the inlet. The inlet is configured to receive at least one hardware fastener. The apparatus also includes a hollow channel that includes a stem portion and a tapered portion between the inlet and the outlet. The tapered portion includes tapered compliant fingers having an initial diameter. The hollow channel is configured to guide the at least one hardware fastener from the inlet to the tapered portion. The tapered compliant fingers are configured to stop the at least one hardware fastener from gravity feeding through the outlet and to retain the at least one hardware fastener within the hollow channel. The tapered portion is configured to radially spread the compliant fingers to an expanded diameter to permit the at least one hardware fastener to release through the outlet.

### TECHNICAL FIELD

This disclosure is directed generally to tools for installing hardware. More specifically, this disclosure is directed to a compliant fastener starter for simultaneous hardware and hardware stackup installation.

### BACKGROUND

During the installation and removal of small hardware stackups (such as screws, washers, nuts, bolts, spacers, and the like), the fasteners may become lost as a result of unintentional dropping. If fasteners are dropped within hardware components or in hard-to-reach spaces that are in proximity to hardware components, the fasteners may not be recoverable. Lost and unrecovered fasteners contribute to a problem referred to as “foreign object debris” (FOD). This problem is pervasive in various types of vehicles, such as aircraft and sea vessels. In these vehicles, there may be a high potential for small fasteners to be dropped, such as during assembly of a motherboard into a computerized device. In maritime and aerospace industries, the FOD problem is associated with foreign object damage to other hardware during processing, transport, or operation.

Standard screw starters can be used to mechanically clamp onto the outside of fasteners or onto driving features of the fasteners. Mechanical clamps often protrude radially from outer perimeters of fasteners, and these types of standard screw starters do not allow for tight clearance installation of the fasteners. Also, standard screw starters do not allow for the simultaneous installation of washers and screws at the same time. Other types of screw starters rely on magnetism to hold hardware stackups. However, magnetized screw starters do not work with non-ferrous, stainless steel, corrosion resistant, or non-magnetic hardware. Magnetized screw starters also allow loose hardware to be dropped inside assemblies. Magnetized screw starters are further unable to retain multiple washers with a screw.

### SUMMARY

This disclosure provides a compliant fastener starter for simultaneous hardware and hardware stackup installation.

In a first embodiment, an apparatus includes an open-mouth inlet at a first end and an outlet at a second end distal from the inlet. The inlet is configured to receive at least one hardware stackup. The apparatus also includes a hollow channel that includes a stem portion and a tapered portion between the inlet and the outlet. The tapered portion includes tapered compliant fingers having an initial diameter. The hollow channel is configured to guide the at least one hardware fastener from the inlet to the tapered portion. The tapered compliant fingers are configured to stop the at least one hardware fastener from gravity feeding through the outlet and to retain the at least one hardware fastener within the hollow channel. The tapered portion is configured, in response to a force applied to the at least one hardware fastener in a longitudinal direction toward the outlet, to radially spread the compliant fingers to an expanded diameter to permit the at least one hardware fastener to release through the outlet. The tapered portion is also configured to automatically retract the compliant fingers after the release.

In a second embodiment, an apparatus includes a tube having an inlet and an outlet. The tube is configured to receive at least one hardware fastener. The tube defines a hollow channel having a tapered end that includes the outlet, and the tapered end includes compliant fingers configured to expand and contract. The hollow channel is configured to guide the at least one hardware fastener from the inlet to the outlet, and the compliant fingers are configured to stop the at least one hardware fastener from gravity feeding through the outlet and to retain the at least one hardware fastener within the hollow channel. The tapered end is configured, in response to a force applied to the at least one hardware fastener in a longitudinal direction toward the outlet, to radially spread the compliant fingers to permit the at least one hardware fastener to release through the outlet.

In a third embodiment, a method includes receiving at least one hardware fastener through an inlet of a compliant fastener starter. The compliant fastener starter also includes an outlet distal from the inlet and a hollow channel. The hollow channel includes a stem portion and a tapered portion between the inlet and the outlet. The method also includes guiding the at least one hardware fastener to the tapered portion, where tapered compliant fingers stop the at least one hardware fastener from gravity feeding through the outlet. The method further includes retaining the at least one hardware fastener within the compliant fastener starter by the tapered compliant fingers having an initial diameter. The method also includes, in response to a force applied to the at least one hardware fastener in a longitudinal direction toward the outlet, spreading the compliant fingers to an expanded diameter to permit the at least one hardware fastener to release through the outlet. In addition, the method includes automatically retracting the compliant fingers after the release.

Other technical features may be readily apparent to one skilled in the art from the following figures, descriptions, and claims.

### BRIEF DESCRIPTION OF THE DRAWINGS

For a more complete understanding of this disclosure and its advantages, reference is now made to the following description, taken in conjunction with the accompanying drawings, in which:

FIGS. 1 through 3 illustrate an example compliant fastener starter for simultaneous hardware installation according to this disclosure; and

FIG. 4 illustrates an example process for simultaneous hardware installation using a compliant fastener starter according to this disclosure.

### DETAILED DESCRIPTION

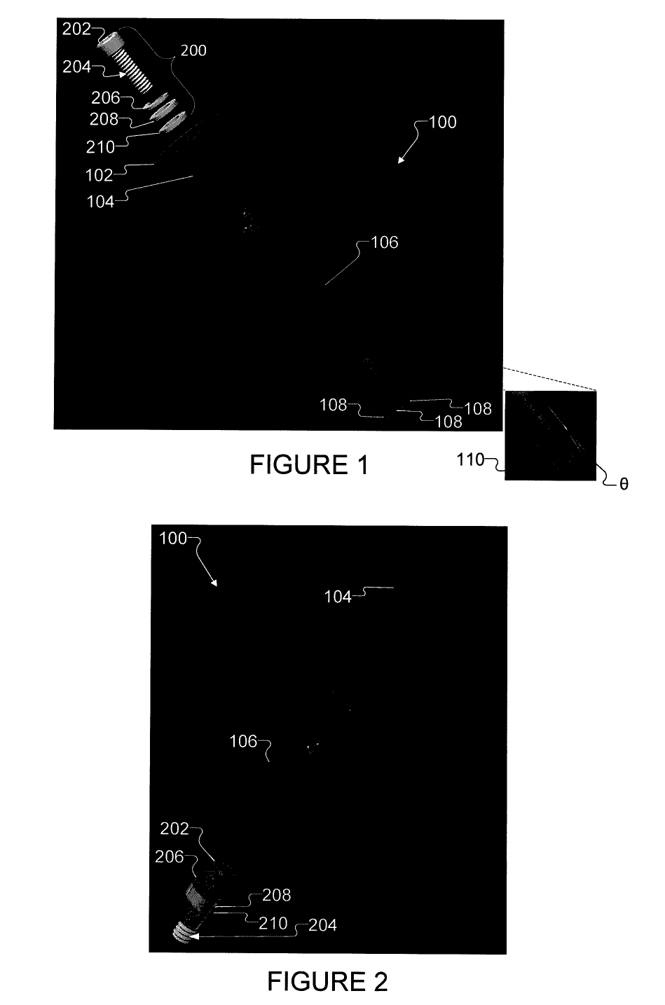

FIGS. 1 through 4, described below, and the various embodiments used to describe the principles of the present invention in this patent document are by way of illustration only and should not be construed in any way to limit the scope of the invention. Those skilled in the art will understand that the principles of the present invention may be implemented in any type of suitably arranged device or system.

FIGS. 1 through 3 illustrate an example compliant fastener starter 100 for simultaneous hardware installation according to this disclosure. The embodiment of the compliant fastener starter shown in FIGS. 1 through 3 is for illustration only. Other embodiments could be used without departing from the scope of this disclosure.

FIG. 1 illustrates a compliant fastener starter 100 that is being loaded with a hardware fastener 200. Components of the hardware fastener 200 shown in FIG. 1 can be inserted into the compliant fastener starter 100, stacked on top of each other within the compliant fastener starter 100, and optionally stored together within the compliant fastener starter 100. The hardware fastener 200 can be installed by driving the hardware fastener 200 into an installation point, thereby installing all elements of the stack at the same time. The compliant fastener starter 100 can be used to install any quantity of washers along with a bolt or screw. In this specific example, the hardware fastener 200 includes a bolt 202 with a head and a narrower threaded portion 204, one locking washer 206, and two flat washers 208-210. In particular embodiments, the bolt 202 can be approximately one-quarter inch long. However, any other suitable hardware fasteners could be used. For instance, the hardware fastener 200 could include an aluminum stud rather than a bolt.

As shown in FIG. 1, the compliant fastener starter 100 represents a single unitary device having the shape of an elongated tube. The compliant fastener starter 100 could be formed from any suitable material(s) and in any suitable manner. For example, the compliant fastener starter 100 could be formed from a thermoplastic material, such as a robust polylactic acid (PLA) or acrylonitrile butadiene styrene (ABS). Also, the compliant fastener starter 100 could be formed using a three-dimensional (3D) printing process or an injection molding process.

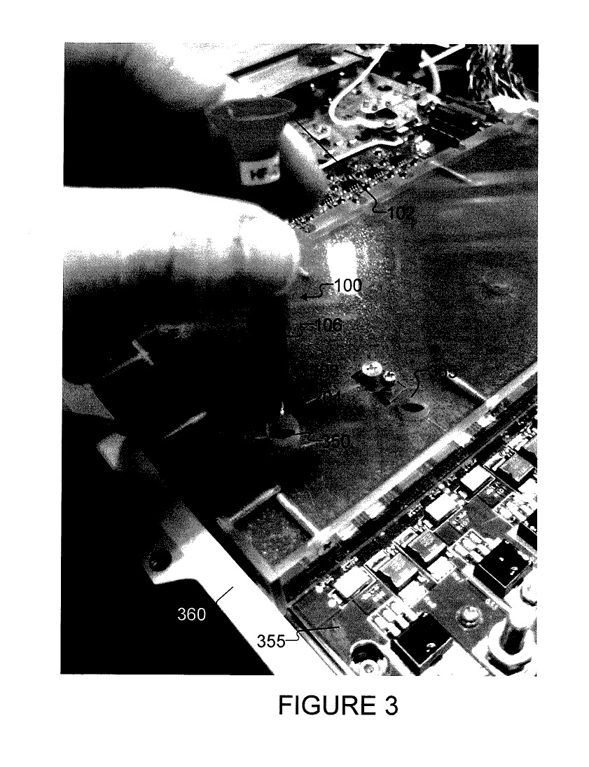

According to embodiments of this disclosure, the compliant fastener starter 100 enables a user to install hardware fasteners into limited access locations or into locations deep within printed circuit board (PCB) cutouts. As a result, the user can avoid the timely and tedious task of manually aligning hardware in PCB cutouts. An example of this is shown in FIG. 3 and described below.

The upper portion of the compliant fastener starter 100 includes a funnel shape that has an open-mouth inlet at a top rim 102 and a narrower transition opening 104. The upper portion can be a hollow truncated cone that includes the top rim 102 as its wide base and includes the transition opening 104 as its narrow base. The width of the top rim 102, as compared to the narrower transition opening 104, provides space for a user to guide the hardware fastener 200 along the interior surface of the upper portion through the narrower transition opening 104. This reduces dropping and reduces the time for aligning an outer perimeter of the hardware fastener 200 with the transition opening 104. The transition opening 104 defines a boundary where the upper portion meets a stem or middle portion 106.

The middle portion 106 of the compliant fastener starter 100 includes a cylindrical shape, which extends between the narrower transition opening 104 and the lower portion of the compliant fastener starter 100. The middle portion 106 includes a hollow channel with a substantially uniform interior diameter throughout its length. In some embodiments, the middle portion 106 is configured to guide the hardware fastener 200. The hardware fastener 200 has a specific outer perimeter cross-sectional shape (such as a circular, star, or irregular shape), and the middle portion 106 of the compliant fastener starter 100 correspondingly includes an interior perimeter cross-sectional shape that could match or approximate the outer perimeter cross-sectional shape of the hardware fastener 200. The inner diameter of the middle portion 106 can also have the same or approximately the same size as the transition opening 104. The size of the inner diameter could be marginally greater than the outer diameter of the hardware fastener 200 so that the hardware fastener 200 within the middle portion is physically restricted from tilting or rotating beyond some marginal amount. As a result, the hardware fastener 200 gravity feeds through the middle portion 106 and lands in coaxial alignment with a longitudinal axis of the middle portion 106. That is, the middle portion 106 guides the hardware fastener 200 using gravity to keep the stack of components in the hardware fastener 200 in alignment with another. The marginal amount is sufficiently small to prevent the elements of the hardware fastener 200 from moving out of alignment.

The wall around the middle portion 106 could have any suitable thickness, such as approximately 0.020 inches. Also, the exterior diameter of the middle portion 106 is sufficiently wide to enable the compliant fastener starter 100 to fit within a specified location, such as within a PCB cutout. Unlike the smaller thickness of the compliant fastener starter 100, commercially available screw starters (such as clamp-style devices) require larger clearances around hardware fasteners, such as approximately three times the screw diameter.

The lower portion of the compliant fastener starter 100 includes tapered compliant fingers 108 to secure the hardware fastener 200. In this example, the lower portion of the compliant fastener starter 100 includes a multiple-slit truncated cone shape. The wider base of the cone shape includes an interior opening through which the hardware fastener transitions from the middle portion 106 into the lower portion the compliant fastener starter 100. In some embodiments, the fingers 108 are identical to each other and are equidistantly spaced apart (such as 120° when three fingers are included or 90° when four fingers are included). The number of fingers 108 in the compliant fastener starter 100 could vary depending on the diameter of the head of the hardware fastener 200. Also, the number of fingers 108 in the compliant fastener starter 100 could vary based on a concentration of internal stresses of the thermoplastic material or other material forming the starter 100. The number of slits can be equal to the number of fingers 108. In other embodiments, one or more of the fingers 108 can be shaped to include some non-separating slits that contribute to retaining small hardware within the compliant fastener starter 100. The slits can be rectangular cutouts, triangular cutouts, cutouts with rounded vertices, or other shapes.

An angle θ of taper in the lower portion of the compliant fastener starter 100 is sufficient to hold the aligned elements of the hardware fastener 200 within the interior of the starter 100 and prevent the hardware fastener 200 from dropping out of an outlet 110 at the bottom of the starter 100. At the same time, the angle θ of taper is sufficient to allow a portion of the hardware fastener 200 (such as a screw, bolt, or stud) to protrude through the outlet 110 beyond the bottom of the compliant fastener starter 100, enabling the protruding portion to be inserted at or align with an installation point. In addition, the angle θ of taper is sufficient to allow the fingers 108 to spread apart radially to allow release of the hardware fastener 200 upon driving (such as torqueing) but also to stop the fingers 108 from spreading beyond the point where the exterior circumference of the fingers 108 equals the exterior circumference of the middle portion 106. That is, the compliant fingers 108 are tapered to an initial diameter but can be expanded to an expanded diameter that allows hardware to exit the outlet of the compliant fastener starter 100. The compliant fingers 108 can then elastically contract radially (such as by retracting) substantially to the initial diameter when no spreading force is applied to the compliant fingers 108. That is, the compliant fingers 108 automatically retract to the original position after the release of the hardware fastener 200 through the outlet 110.

The funnel-shaped upper portion allows a user to quickly drop hardware into the compliant fastener starter 100 for automatic alignment. The user can choose to manually or via an automated process insert a single element or multiple elements of a hardware fastener into the funnel-shaped upper portion at the same time and then subsequently drive the hardware into an installation point and out of the compliant fastener starter 100. Alternatively, the user can choose to insert multiple elements of a hardware fastener into the funnel-shaped upper portion consecutively and then subsequently drive the hardware into an installation point. The compliant fastener starter 100 can contain all of the inserted hardware elements until the hardware fastener is fully installed at an installation point, thereby mitigating FOD damage and mitigating issues associated with loosely-installed fasteners.

Note that the internal dimensions of the compliant fastener starter 100 can be selected according to the outer diameter of the hardware fasteners (for example, a stack of screws, washers, nuts, bolts, spacers, and the like) to be installed. Differently-sized compliant fastener starters 100 can be used for differently-sized hardware fasteners.

As shown in FIG. 2, the compliant fastener starter 100 of FIG. 1 has been loaded with the hardware fastener 200. The hardware fastener 200 is coaxially stacked within the compliant fastener starter 100 and is securely retained by the compliant fingers 108.

FIG. 3 shows the compliant fastener starter 100 being held over a PCB cutout 350 and held in the hand of a user. The diameter of the PCB cutout 350 is larger than the exterior diameter of the middle portion 106, but the difference could be minimal. An installation point is disposed on a PCB 355 and is accessible through the PCB cutout 350. The installation point can include a hole or recess configured to couple to the threaded portion 204 of the hardware fastener 200. As a particular example, the user can secure the PCB 355 into a fixed location within a device 360 by tightly torqueing a bolt into the installation point. The user can insert a long bit through the top rim 102 of the compliant fastener starter 100 to reach the bolt head in the compliant fastener starter 100.

The PCB 355 itself could include an additional PCB cutout 365, which may be the same as or different than the PCB cutout 350. When the PCB cutouts 350 and 365 are the same size, the same compliant fastener starter 100 can be used to install first hardware into a first installation point accessible through the PCB cutout 350 and to install second hardware into a second installation point accessible through the PCB cutout 365. When the PCB cutouts 350 and 365 are of different sizes, different compliant fastener starters 100 can be used.

Although FIGS. 1 through 3 illustrate one example of a compliant fastener starter 100, various changes may be made to FIGS. 1 through 3. For example, the sizes, shapes, and dimensions of various parts of the compliant fastener starter 100 are for illustration only. Also, any suitable hardware fasteners having any suitable number of elements could be used with the compliant fastener starter 100.

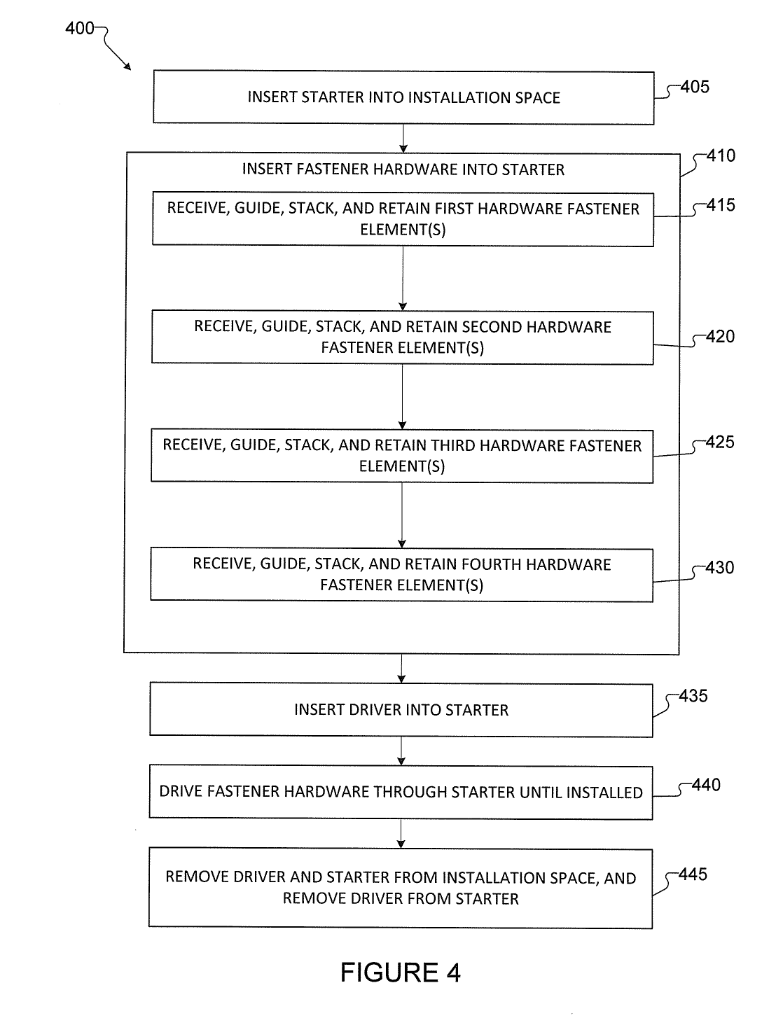

FIG. 4 illustrates an example process 400 for simultaneous hardware installation using a compliant fastener starter according to this disclosure. The embodiment of the process 400 shown in FIG. 4 is for illustration only. Other embodiments could be used without departing from the scope of this disclosure. For ease of explanation, the process 400 is described as being implemented using the compliant fastener starter 100 and hardware fastener 200 of FIG. 1 with the structure of FIG. 3.

In block 405, a user inserts a compliant fastener starter into an installation space. This could include, for example, the user inserting the compliant fastener starter 100 into a PCB cutout 440 or 465, a blind hole, or other hard-to-reach place.

In block 410, the user inserts a hardware fastener into the compliant fastener starter. For example, in block 415, the compliant fastener starter receives a first hardware fastener element, such as the flat washer 210. In block 420, the compliant fastener starter receives a second hardware fastener element, such as the flat washer 208. In block 425, the compliant fastener starter receives a third hardware fastener element, such as the locking washer 206. In block 430, the compliant fastener starter receives a fourth hardware fastener element, such as the bolt 202.

In block 435, the user inserts a driver into the compliant fastener starter. For example, the user could insert a suitably long Phillips-head screw driver to mate with the Phillips-head recess within the head of the bolt 202. In block 440, the user installs the hardware into an installation point located at the bottom of the installation space. That is, the user drives the hardware fastener 200 through the compliant fastener starter 100 until tightly fastened into the installation point. For example, the user can apply a force against the bolt in a longitudinal direction toward the bottom outlet of the compliant fastener starter 100. The user may torque the bolt 202 using the driver, or the user may use a punch to apply a blunt force against a stud.

In block 445, the user removes the driver and the compliant fastener starter from the installation space and removes the driver from the compliant fastener starter. By pulling the compliant fastener starter 100 off of the hardware fastener 200, the user enables the compliant fingers 108 to retract to a tapered formation having substantially the same initial diameter from a spread-apart formation having an expanded diameter.

The process 400 can be repeated using the same compliant fastener starter 100 to install multiple sets of hardware fasteners (such as screw and multiple washers) into one or more other installation points. Also, different compliant fastener starters could be used to install hardware fasteners of different sizes or in different locations.

Although FIG. 4 illustrates one example of a process 400 for simultaneous hardware installation using a compliant fastener starter, various changes may be made to FIGS. 4. For example, while FIG. 4 indicates that a hardware fastener includes four elements, the hardware fastener could include any number of elements. Also, while shown as a series of steps, various steps in FIG. 4 could overlap, occur in parallel, occur in a different order, or occur any number of times.

It may be advantageous to set forth definitions of certain words and phrases used throughout this patent document. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims is intended to invoke 35 U.S.C. §112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. §112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An apparatus comprising:
an open-mouth inlet at a first end, the inlet configured to receive at least one hardware fastener;
an outlet at a second end distal from the inlet;
a hollow channel including a stem portion and a tapered portion between the inlet and the outlet, the tapered portion including tapered compliant fingers having an initial diameter, the hollow channel configured to guide the at least one hardware fastener from the inlet to the tapered portion, the tapered compliant fingers configured to stop the at least one hardware fastener from gravity feeding through the outlet and to retain the at least one hardware fastener within the hollow channel;
wherein the tapered portion is configured, in response to a force applied to the at least one hardware fastener in a longitudinal direction toward the outlet, to radially spread the compliant fingers to an expanded diameter to permit the at least one hardware fastener to release through the outlet; and
wherein the tapered portion is configured to automatically retract the compliant fingers after the release.

2. The apparatus of claim 1, further comprising:
a conical portion that includes the inlet as its wider base and a transition opening as its narrower base, the transition opening defining a boundary between the conical portion and the stem portion.

3. The apparatus of claim 1, wherein the hollow channel is configured to receive multiple elements of the at least one hardware fastener and to hold the multiple elements of the at least one hardware fastener in longitudinal coaxial alignment.

4. The apparatus of claim 1, wherein the tapered portion comprises multiple cutout slits that separate the compliant fingers from one another.

5. The apparatus of claim 1, wherein the apparatus comprises a single unitary device.

6. The apparatus of claim 1, wherein the stem portion is a cylindrical tube.

7. The apparatus of claim 1, wherein the stem portion has an inner cross-sectional perimeter shape that substantially matches an outer cross-sectional perimeter shape of the at least one hardware fastener.

8. The apparatus of claim 1, wherein an outer diameter of the stem portion is greater than an inner diameter of the stem portion by about 0.02 inches.

9. An apparatus comprising:
a tube having an inlet and an outlet, the tube configured to receive at least one hardware fastener;
wherein the tube defines a hollow channel having a tapered end comprising the outlet, the tapered end including compliant fingers configured to expand and contract;
wherein the hollow channel is configured to guide the at least one hardware fastener from the inlet to the outlet, the compliant fingers configured to stop the at least one hardware fastener from gravity feeding through the outlet and to retain the at least one hardware fastener within the hollow channel; and
wherein the tapered end is configured, in response to a force applied to the at least one hardware fastener in a longitudinal direction toward the outlet, to radially spread the compliant fingers to permit the at least one hardware fastener to release through the outlet.

10. The apparatus of claim 9, wherein the tube comprises a conical portion that includes the inlet, the conical portion configured to receive the at least one hardware fastener and to guide the at least one hardware fastener toward the outlet.

11. The apparatus of claim 9, wherein the hollow channel is configured to receive multiple elements of the at least one hardware fastener and to hold the multiple elements of the at least one hardware fastener in longitudinal coaxial alignment.

12. The apparatus of claim 9, wherein the tapered end comprises multiple cutout slits that separate the compliant fingers from one another.

13. The apparatus of claim 9, wherein the apparatus comprises a single unitary device.

14. The apparatus of claim 9, wherein a middle portion of the tube is cylindrical.

15. The apparatus of claim 9, wherein the hollow channel has a shape that substantially matches a shape of the at least one hardware fastener.

16. The apparatus of claim 9, wherein a wall of the tube is about 0.02 inches thick.

17. A method comprising:
receiving at least one hardware fastener through an inlet of a compliant fastener starter, the compliant fastener starter also comprising an outlet distal from the inlet and a hollow channel, the hollow channel including a stem portion and a tapered portion between the inlet and the outlet;
guiding the at least one hardware fastener to the tapered portion, where tapered compliant fingers stop the at least one hardware fastener from gravity feeding through the outlet;
retaining the at least one hardware fastener within the compliant fastener starter by the tapered compliant fingers having an initial diameter;
in response to a force applied to the at least one hardware fastener in a longitudinal direction toward the outlet, spreading the compliant fingers to an expanded diameter to permit the at least one hardware fastener to release through the outlet; and
automatically retracting the compliant fingers after the release.

18. The method of claim 17, wherein the compliant fastener starter further comprises a conical portion that includes the inlet, the conical portion configured to receive the at least one hardware fastener and to guide the at least one hardware fastener toward the outlet.

19. The method of claim 17, wherein:
receiving the at least one hardware fastener comprises receiving multiple elements of the at least one hardware fastener; and
the method further comprises holding the multiple elements of the at least one hardware fastener in longitudinal coaxial alignment.

20. The method of claim 17, wherein the compliant fastener starter is configured to allow a user to insert a driver through the compliant fastener starter and to install the at least one hardware fastener into an installation point.
